(19) United States
(12) Patent Application Publication
(10) Pub. No.: US 2023/0108075 A1
(43) Pub. Date: Apr. 6, 2023

(54) BEHAVIOR CLASSIFICATION APPARATUS, BEHAVIOR CLASSIFICATION METHOD, AND PROGRAM

(71) Applicant: NIPPON TELEGRAPH AND TELEPHONE CORPORATION, Tokyo (JP)

(72) Inventors: Masaaki MATSUMURA, Musashino-shi, Tokyo (JP); Akio KAMEDA, Musashino-shi, Tokyo (JP); Shinya SHIMIZU, Musashino-shi, Tokyo (JP); Hajime NOTO, Musashino-shi, Tokyo (JP); Yoshinori KUSACHI, Musashino-shi, Tokyo (JP)

(73) Assignee: NIPPON TELEGRAPH AND TELEPHONE CORPORATION, Tokyo (JP)

(21) Appl. No.: 17/800,572

(22) PCT Filed: Feb. 20, 2020
(86) PCT No.: PCT/JP2020/006773

§ 371 Date: Aug. 18, 2022

(51) Int. Cl. G06V 10/764; G06T 7/73

(52) U.S. Cl. CPC G06V 10/764; G06T 7/73; G06T 2207/30241; G06T 2207/10016

(57) ABSTRACT

A behavior classifier includes a coordinate estimation unit that receives a plurality of frames in chronological order as an input to estimate a keypoint coordinate group for each of the plurality of frames and to generate a chronological keypoint coordinate group for the plurality of input frames; a matrix generation unit that generates a trajectory matrix and generates a trajectory matrix group in which trajectory matrices are collected for all of keypoints defined for the object; and a behavior classification unit that classifies a behavior of the object based on the trajectory matrix group. Each of the plurality of frames captures an object as a moving image. The keypoint coordinate group is a set of two-dimensional coordinates of a keypoint defined for the object. The chronological keypoint coordinate group is a set of the keypoint coordinate groups arranged in chronological order. The trajectory matrix is a matrix in which two-dimensional coordinates of the keypoint of the chronological keypoint coordinate group are plotted as a trajectory of a curve of the two-dimensional coordinates that is smoothly continuous in chronological order.

### TECHNICAL FIELD

The present invention relates to a behavior classifier, a behavior classification method, and a program.

### BACKGROUND ART

There is a technical field for classifying a behavior of an object captured in a frame of a moving image based on at least one of a set of two-dimensional coordinates of a keypoint defined for the object (hereinafter referred to as a “keypoint coordinate group”) and a set of keypoint coordinate groups arranged in chronological order (hereinafter referred to as a “chronological keypoint coordinate group”).

Keypoints mentioned here include those defined in the Microsoft Common Object in Context (MS COCO) dataset, for example, illustrated in FIG. 6. A keypoint 100 is a keypoint representing the position of the nose. A keypoint 101 is a keypoint representing the position of the left eye. A keypoint 102 is a keypoint representing the position of the right eye. Keypoints 103 to 116 are keypoints representing the positions of other parts defined for the object.

A method of classifying a behavior of an objects may include, for example, one in which a frame group of frames capturing an object is received as an input to classify a behavior of the object in machine learning using deep learning. In this case, a pre-trained model (e.g., represented using convolutional neural networks (CNNs) or deep neural networks (DNNs)) in which each frame of the frame group is used as an input to output a keypoint coordinate group is used in estimating a keypoint coordinate group that is a set of two-dimensional coordinates (x and y coordinates) of each keypoint in the frame. In addition, the pre-trained model that uses a keypoint coordinate group or a chronological keypoint coordinate group as an input to output a probability of the behavior of the object for each classification (pattern) (which will be referred to as a “classification probability” below) is used to classify a behavior of the object.

In general, a method of classifying a behavior of an object using a chronological keypoint coordinate group for a plurality of frames arranged in chronological order can improve classification accuracy more than a method of classifying a behavior of an object using a keypoint coordinate group for a single frame of a chronological frame group of a moving image.

NPL 1 discloses a technique for improving accuracy in classification of a behavior of an object in each frame of N chronological frames (N is an integer equal to or greater than 2) of a moving image using a pre-trained model that uses, as an input, a chronological keypoint coordinate group (an array in which 28*N coordinates are stored) in which the two-dimensional coordinates of 14 keypoints of the skeleton of a human are stored and outputs the classification result of the behavior of the object (detection of a fall in this case). In addition, NPL 2 discloses a method to keep chronological features in which, while a keypoint coordinate group is used as an input, long/short-term memory is also used to detect a fall of a human.

CITATION LIST

Non Patent Literature
NPL 1: He Xu, Shen Leixian, Qingyun Zhang, Guoxu Cao, “Fall Behavior Recognition based on Deep Learning and Image Processing” in International Journal of Mobile Computing and Multimedia Communications 9 (4): 1-15, October 2018.
NPL 2: A. Shojaei-Hashemi, P. Nasiopoulos, J. J. Little, and M. T. Pourazad, “Video-based Human Fall Detection in Smart Homes Using Deep Learning”, in Circuits and Systems (ISCAS), 2018 IEEE International Symposium on. IEEE, 2018, pp. 1-5.

### SUMMARY OF THE INVENTION

### Technical Problem

FIG. 7 is a diagram illustrating an exemplary array of a chronological keypoint coordinate group provided as an input to a model in the related art. In addition, FIG. 8 is a diagram showing a graph of an exemplary movement of each keypoint of the chronological keypoint coordinate group of the array example of FIG. 7 with respect to each axis. In deep learning using a CNN, convolution is performed using a group of signals adjacent to a signal to be convoluted. Thus, when the CNN is applied directly to the chronological keypoint coordinate group in the method of the related art, it is easy to ascertain the increase and decrease of a keypoint for each axis (corresponding to a change of speed) because effort is made to analyze the graph of FIG. 8, but it is difficult to ascertain characteristics of spatial movement of the keypoint (e.g., circular movement) on the two-dimensional plane in a frame.

Taking the above circumstances into consideration, the present invention aims to provide a behavior classifier, a behavior classification method, and a program which can improve accuracy in classification of a behavior of an object captured in a chronological frame group of a moving image.

### Means for Solving the Problem

An aspect of the present invention is a behavior classifier including a coordinate estimation unit configured to receive a plurality of frames in chronological order as an input to estimate a keypoint coordinate group for each of the plurality of frames and to generate a chronological keypoint coordinate group for the plurality of input frames, each of the plurality of frames capturing an object as a moving image, the keypoint coordinate group being a set of two-dimensional coordinates of a keypoint defined for the object, the chronological keypoint coordinate group being a set of the keypoint coordinate groups arranged in chronological order; a matrix generation unit configured to generate a trajectory matrix and generate a trajectory matrix group in which trajectory matrices are collected for all of keypoints defined for the object, the trajectory matrix being a matrix in which two-dimensional coordinates of the keypoint of the chronological keypoint coordinate group are plotted as a trajectory of a curve of the two-dimensional coordinates that is smoothly continuous in chronological order; and a behavior classification unit configured to classify a behavior of the object based on the trajectory matrix group.

An aspect of the present invention is a behavior classification method performed by a behavior classifier, the behavior classification method including receiving a plurality of frames in chronological order as an input to estimate a keypoint coordinate group for each frame and to generate a chronological keypoint coordinate group for the plurality of input frames, each of the plurality of frames capturing an object as a moving image, the keypoint coordinate group being a set of two-dimensional coordinates of a keypoint defined for the object, the chronological keypoint coordinate group being a set of the keypoint coordinate groups arranged in chronological order; generating a trajectory matrix and generating a trajectory matrix group in which trajectory matrices are collected for all of keypoints defined for the object, the trajectory matrix being a matrix in which two-dimensional coordinates of the keypoint of the chronological keypoint coordinate group are plotted as a trajectory of a curve of the two-dimensional coordinates that is smoothly continuous in chronological order; and classifying a behavior of the object based on the trajectory matrix group.

An aspect of the present invention is a program that causes a computer to function as the behavior classifier.

### Effects of the Invention

The present invention can improve accuracy in classification of a behavior of an object captured in a chronological frame group of a moving image.

### BRIEF DESCRIPTION OF DRAWINGS

FIG. 1 is a diagram illustrating an exemplary configuration of a behavior classifier according to an embodiment.

FIG. 2 is a diagram illustrating an exemplary hardware configuration of the behavior classifier according to the embodiment.

FIG. 3 is a diagram illustrating an exemplary trajectory matrix in which a trajectory of two-dimensional coordinates of a keypoint are plotted according to the embodiment.

FIG. 4 is a flowchart showing an exemplary operation of the behavior classifier according to the embodiment.

FIG. 5 is a flowchart showing an exemplary operation of a matrix generation unit according to the embodiment.

FIG. 6 is a diagram illustrating exemplary keypoints defined in the MS COCO dataset.

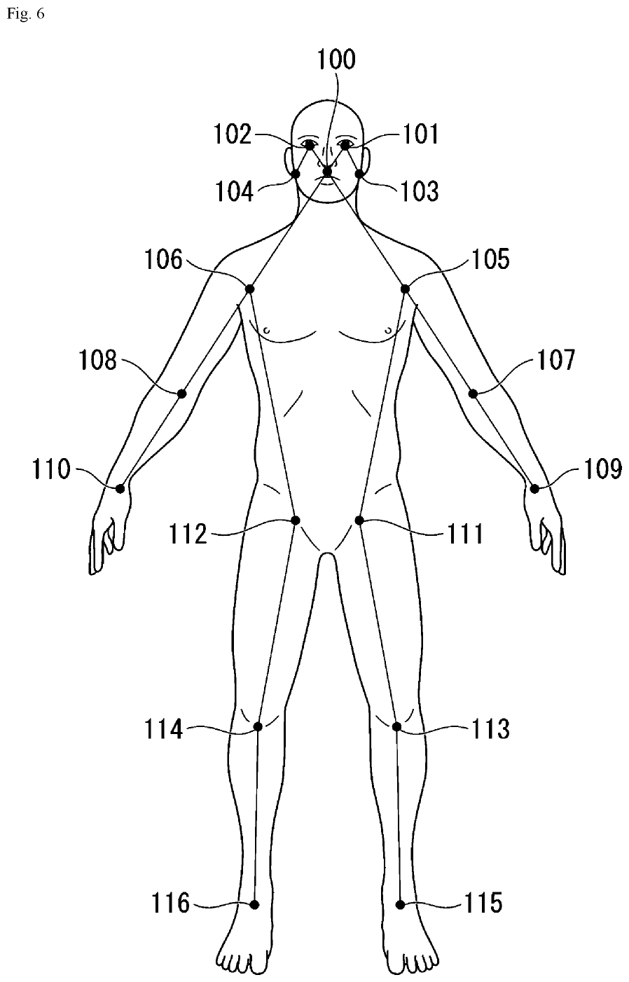

FIG. 7 is a diagram illustrating an exemplary array of a chronological keypoint coordinate group provided as an input to a model in the related art.

FIG. 8 is a diagram illustrating exemplary movements of keypoints of the chronological keypoint coordinate group on each axis.

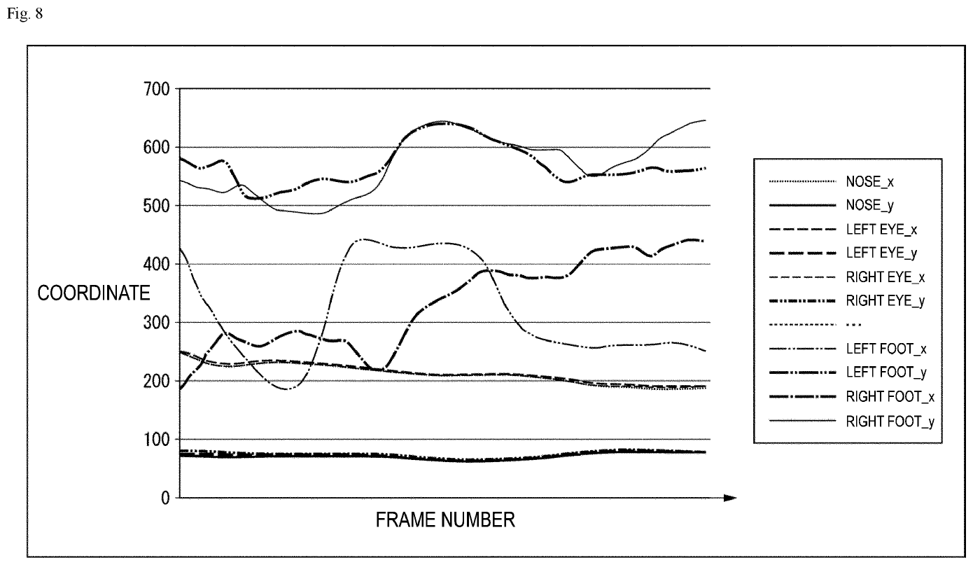

### DESCRIPTION OF EMBODIMENTS

Embodiments of the present invention will be described in detail with reference to the drawings.

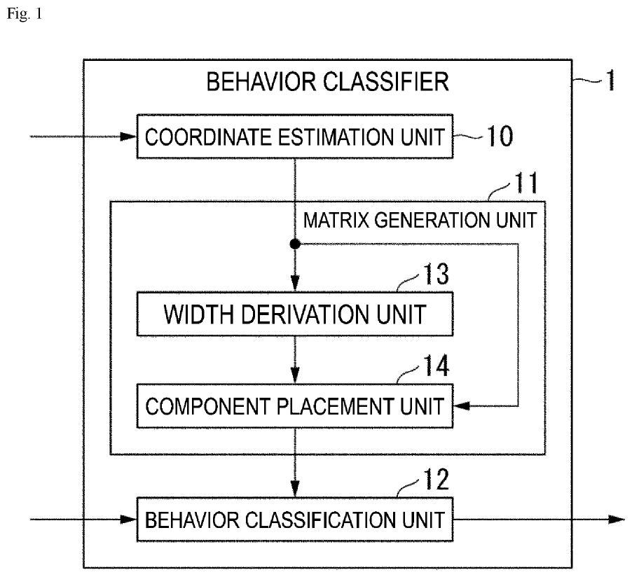

FIG. 1 is a diagram illustrating an example of a configuration of a behavior classifier 1. The behavior classifier 1 is an apparatus that classifies a behavior of an object captured in a moving image. The behavior classifier 1 includes a coordinate estimation unit 10, a matrix generation unit 11, and a behavior classification unit 12. The matrix generation unit 11 includes a width derivation unit 13 and a component placement unit 14.

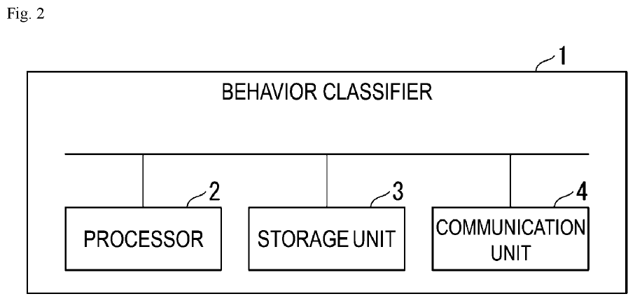

FIG. 2 is a diagram illustrating an exemplary hardware configuration of the behavior classifier 1. The behavior classifier 1 includes a processor 2, a storage unit 3, and a communication unit 4.

Some or all of the coordinate estimation unit 10, the matrix generation unit 11, and the behavior classification unit 12 are implemented in software when the processor 2 such as a central processing unit (CPU) executes a program stored in the storage unit 3 having a non-volatile recording medium (non-temporary recording medium). The program may be recorded on a computer-readable recording medium. The computer-readable recording medium is, for example, a portable medium such as a flexible disk, a magneto-optical disc, a read only memory (ROM), or a compact disc read only memory (CD-ROM) or a non-temporary recording medium such as a storage device such as a hard disk built in a computer system. The communication unit 4 may receive the program via a communication line. The communication unit 4 may transmit a classification result of a behavior via a communication line.

Some or all of the coordinate estimation unit 10, the matrix generation unit 11, and the behavior classification unit 12 may be implemented using hardware including, for example, an electronic circuit or circuitry in which a large scale integration circuit (LSI), an application-specific integrated circuit (ASIC), a programmable logic device (PLD), a field programmable gate array (FPGA), or the like is used.

Hereinafter, a matrix in which two-dimensional coordinates of each keypoint of a chronological keypoint coordinate group are plotted as a trajectory of a curve of two-dimensional coordinates that is smoothly continuous in chronological order will be referred to as a “trajectory matrix”. The behavior classifier 1 generates, for each keypoint defined for an object, a trajectory matrix corresponding to the frame resolution. The behavior classifier 1 estimates a behavior of the object receiving, as an input of machine learning using deep learning, trajectory matrices collected for all keypoints defined for the object (which will be referred to as a “trajectory matrix group”).

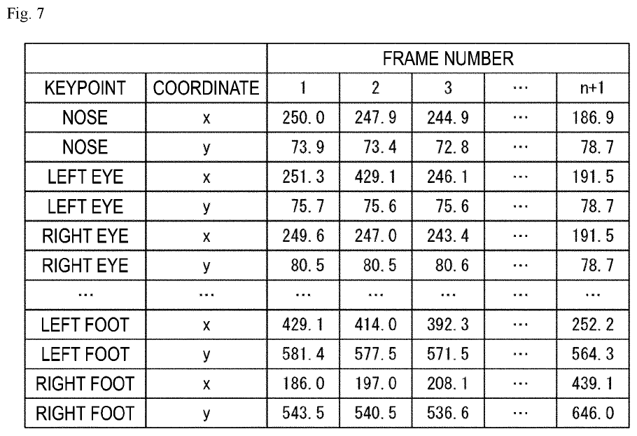

The coordinate estimation unit 10 illustrated in FIG. 1 receives an input of a plurality of frames in chronological order in which an object has been captured as a moving image from a predetermined apparatus (not illustrated). The coordinate estimation unit 10 receives an input of a pre-trained model for estimating a keypoint coordinate group from a predetermined apparatus. The pre-trained model for estimating a keypoint coordinate group is a model that has been trained in machine learning using deep learning in which frames capturing the object are received as an input to output a keypoint coordinate group. When a plurality of frames are provided to the model as inputs, the coordinate estimation unit 10 collects as many keypoint coordinate groups as the number of frames and outputs a chronological keypoint coordinate group as a matrix as illustrated in FIG. 7.

The matrix generation unit 11 illustrated in FIG. 1 receives the input of the chronological keypoint coordinate group from the coordinate estimation unit 10 and outputs a trajectory matrix group. The matrix generation unit 11 includes the width derivation unit 13 and the component placement unit 14. The width derivation unit 13 receives the input of the chronological keypoint coordinate group and outputs a trajectory width that is a width (thickness) of the trajectory. The component placement unit 14 receives the inputs of the chronological keypoint coordinate groups and the trajectory width and outputs a trajectory matrix group.

Maximum values (xMax, yMax) and minimum values (xMin, yMin) of all keypoints stored in the chronological keypoint coordinate group for each axis are calculated, and the value of the result obtained by multiplying a greater value or a smaller value among a diagonal distance or an axial distance (xMax−xMin or yMax−yMin) by a predetermined ratio (e.g., 5%, etc.) may be used as the trajectory width. In addition, a uniform value may be used as a trajectory width.

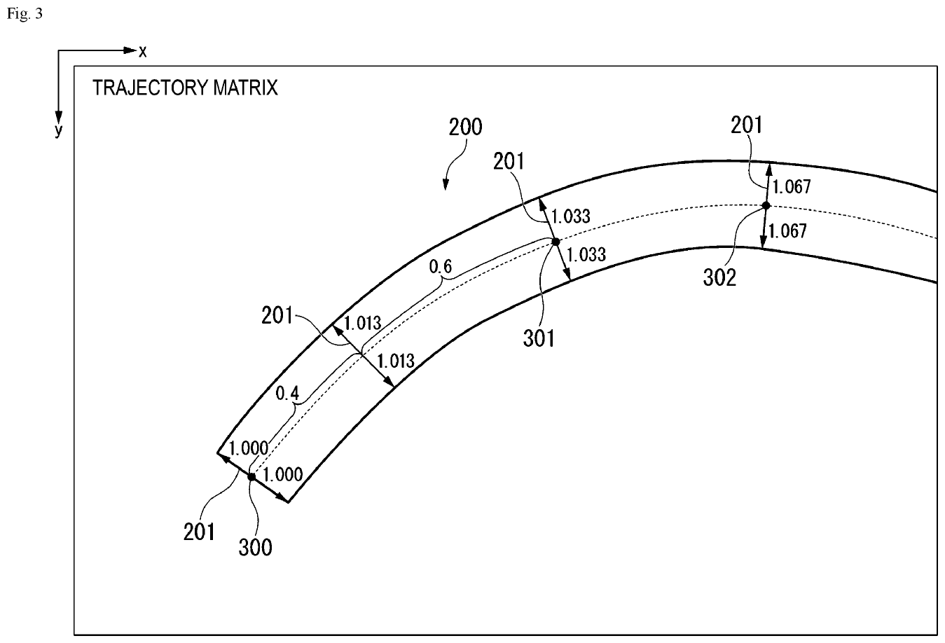

FIG. 3 is a diagram illustrating an exemplary trajectory matrix in which a trajectory 200 of two-dimensional coordinates of a keypoint is plotted. In FIG. 3, the component placement unit 14 plots the two-dimensional coordinates of a target keypoint of a chronological keypoint coordinate group on a matrix as a curve of two-dimensional coordinates having a trajectory width 201 using a spline curve in chronological order. In this way, the component placement unit 14 generates a trajectory matrix. In FIG. 3, the frame number associated with a component 300 of the trajectory matrix is 1, the frame number associated with a component 301 of the trajectory matrix is 2, and the frame number associated with a component 302 of the trajectory matrix is 3. Initialization is performed using an initial value of the trajectory matrix, for example, 0. Component values on the trajectory 200 are determined such that, for example, the component value of the first frame arranged in chronological order is “1.000” and the value increases by 1/30 (which is 0.033) for each frame in a case in which the frame rate of the moving image is 30 fps. “1.000”, “1.013”, “1.033”, and “1.067” shown in FIG. 3 each represent component values. Further, the component values on the trajectory width 201 in the direction orthogonal to the trajectory 200 plotted as the spline curve are the same value, and component values of the frames are determined by using, for example, linear interpolation. The component placement unit 14 plots trajectories of all keypoints on matrices, and then outputs a trajectory matrix group in which the matrices are collected.

The behavior classification unit 12 illustrated in FIG. 1 inputs the trajectory matrix group from the behavior classification unit 12. The behavior classification unit 12 inputs a pre-trained model for behavior classification from a predetermined apparatus. A pre-trained model for behavior classification is a model that has been trained in machine learning using deep learning of each trajectory matrix, with the trajectory matrix group as an input and a classification probability of a behavior of the object as an output. The behavior classification unit 12 outputs the classification probability to a predetermined apparatus (not illustrated). The pre-trained model for behavior classification is expressed by using, for example, a CNN.

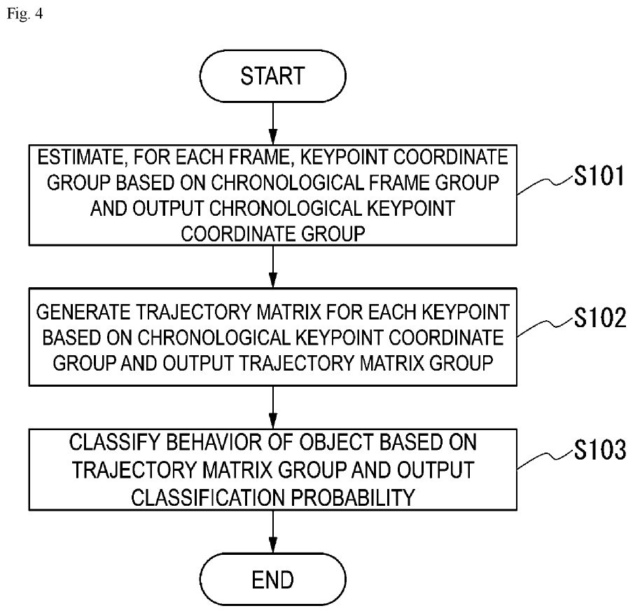

Next, an exemplary operation of the behavior classifier 1 will be described. FIG. 4 is a flowchart showing an exemplary operation of the behavior classifier 1. The behavior classifier 1 receives, as an input, a plurality of frames in chronological order in which an object is captured as a moving image from a predetermined apparatus. The behavior classifier 1 receives, as an input, a pre-trained model that estimates a keypoint coordinate group from a predetermined apparatus. The coordinate estimation unit 10 generates a keypoint coordinate group of the object for each frame. When the plurality of frames are provided as inputs, the coordinate estimation unit 10 collects the keypoint coordinate groups for the input frames to output a chronological keypoint coordinate group as a matrix as illustrated in FIG. 7 (step S101).

The matrix generation unit 11 receives the input of the chronological keypoint coordinate group from the coordinate estimation unit 10. The matrix generation unit 11 generates a trajectory matrix as illustrated in FIG. 3 for each keypoint and outputs a trajectory matrix group in which all keypoints have been collected (step S102).

The behavior classification unit 12 receives the input of the trajectory matrix group from the behavior classification unit 12. The behavior classification unit 12 receives an input a pre-trained model for behavior classification from a predetermined apparatus. The behavior classification unit 12 outputs a classification probability of a behavior of the object to a predetermined apparatus (not illustrated) (step S103).

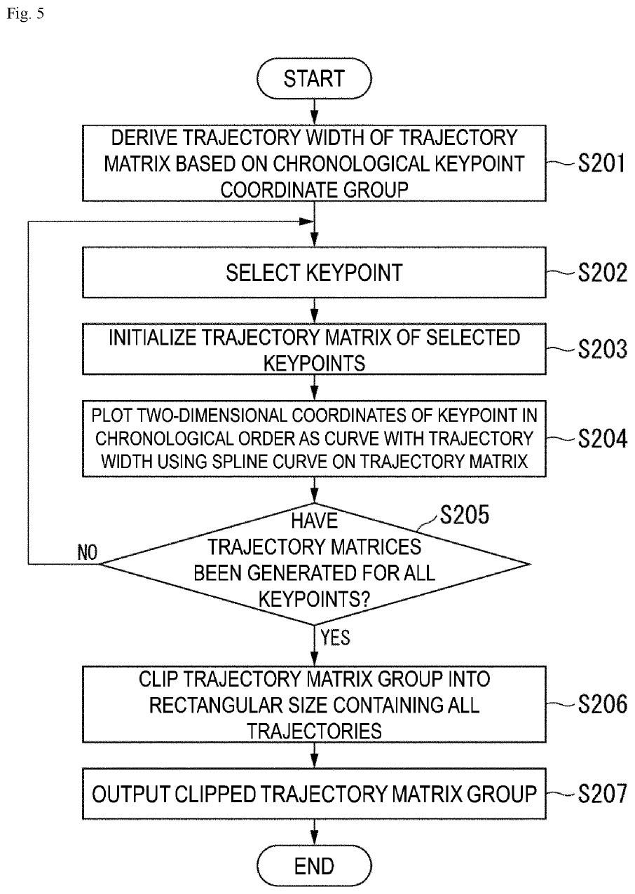

FIG. 5 is a flowchart showing an exemplary operation of the matrix generation unit 11. The width derivation unit 13 receives an input of the chronological keypoint coordinate group from the coordinate estimation unit 10. The width derivation unit 13 derives a trajectory width based on the keypoint coordinate group and outputs the trajectory width to the component placement unit 14 (step S201).

The component placement unit 14 receives an input of the chronological keypoint coordinate group from the coordinate estimation unit 10. The component placement unit 14 receives an input of the trajectory width from the width derivation unit 13. The component placement unit 14 selects one keypoint from the keypoints defined for the object (step S202).

The component placement unit 14 initializes each component value of the trajectory matrix of the selected keypoint to, for example, zero (step S203).

The component placement unit 14 plots two-dimensional coordinates of the target keypoint on a matrix as illustrated in FIG. 3 in chronological order as a curve with the trajectory width in a spline curve. The component placement unit 14 places component values (e.g., frame numbers) in chronological order as component values in the trajectory matrix, and generates component values between two-dimensional coordinates of the keypoint interpolated in the spline curve on the trajectory matrix using, for example, linear interpolation (step S204).

The component placement unit 14 determines whether trajectory matrices have been generated for all of the keypoints defined for the object (step S205). If it is determined that trajectory matrix has not been generated for any keypoint of the chronological keypoint coordinate group (No in step S205), the component placement unit 14 returns the processing back to step S202.

If it is determined that trajectory matrices have been generated for all of the keypoints defined for the object (Yes in step S205), the component placement unit 14 clips a trajectory matrix group in which the trajectory matrices for all of the keypoints have been collected into a rectangular size containing all of the trajectories (e.g., a rectangular size with each maximum value and each minimum value of each axis for all of the keypoints described above) (step S206). Then, the component placement unit 14 outputs the clipped trajectory matrix group to the behavior classification unit 12 (step S207).

As described above, the coordinate estimation unit 10 estimates a keypoint coordinate group which is a set of two-dimensional coordinates of each keypoint for each of a plurality of frames arranged in chronological order and generates a chronological keypoint coordinate group. The matrix generation unit 11 generates a trajectory matrix group in which trajectory matrices are collected for all keypoints defined for an object, each trajectory matrix being a matrix in which two-dimensional coordinates of each keypoint of the chronological keypoint coordinate group are plotted as a trajectory of a curve of two-dimensional coordinates that is smoothly continuous in chronological order. The behavior classification unit 12 classifies a behavior of the object based on the trajectory matrix group, and outputs a classification probability to a predetermined apparatus.

In this manner, the matrix generation unit 11 generates, for each keypoint, a trajectory matrix describing chronological movement of each keypoint on a two-dimensional plane of an input frame. By plotting the two-dimensional coordinates of each keypoint on the trajectory matrix as a trajectory of a curve of two-dimensional coordinates that is smoothly continuous in chronological order, the behavior classification unit 12 can receive, as an input, a feature of a motion of a keypoint on a two-dimensional plane in a frame in an easy-to-understand form and can effectively use a two-dimensional convolution operation in machine learning using deep learning, and thus can improve the accuracy in classification of a behavior of an object captured in a chronological frame group of a moving image.

Further, the trajectory matrices may be scaled or normalized, and the trajectory width may be changed according to the aspect ratio, or a constant value may be used.

Although the embodiment of the present invention has been described in detail with reference to the drawings, a specific configuration is not limited to the embodiment, and a design or the like in a range that does not depart from the gist of the present invention is included.

### INDUSTRIAL APPLICABILITY

The present invention can be applied to an apparatus for classifying a behavior of an object.

### REFERENCE SIGNS LIST

1 Behavior classifier
2 Processor
3 Storage unit
4 Communication unit
10 Coordinate estimation unit
11 Matrix generation unit
12 Behavior classification unit
13 Width derivation unit
14 Component placement unit
100 to 116 Keypoint
200 Trajectory
201 Trajectory width
300 to 302 Component

1. A behavior classifier comprising:
a processor; and
a storage medium having computer program instructions stored thereon, when executed by the processor, perform to:
receive a plurality of frames in chronological order as an input to estimate a keypoint coordinate group for each of the plurality of frames and to generate a chronological keypoint coordinate group for the plurality of input frames, each of the plurality of frames capturing an object as a moving image, the keypoint coordinate group being a set of two-dimensional coordinates of a keypoint defined for the object, the chronological keypoint coordinate group being a set of the keypoint coordinate groups arranged in chronological order;
generate a trajectory matrix and generate a trajectory matrix group in which trajectory matrices are collected for all of keypoints defined for the object, the trajectory matrix being a matrix in which two-dimensional coordinates of the keypoint of the chronological keypoint coordinate group are plotted as a trajectory of a curve of the two-dimensional coordinates that is smoothly continuous in chronological order; and
classify a behavior of the object based on the trajectory matrix group.

2. The behavior classifier according to claim 1, wherein the computer program instructions further perform to generates a component value by linearly interpolating component values of the two-dimensional coordinates for the trajectory.

3. A behavior classification method performed by a behavior classifier, the behavior classification method comprising:
receiving a plurality of frames in chronological order as an input to estimate a keypoint coordinate group for each frame and to generate a chronological keypoint coordinate group for the plurality of input frames, each of the plurality of frames capturing an object as a moving image, the keypoint coordinate group being a set of two-dimensional coordinates of a keypoint defined for the object, the chronological keypoint coordinate group being a set of the keypoint coordinate groups arranged in chronological order;
generating a trajectory matrix and generating a trajectory matrix group in which trajectory matrices are collected for all of keypoints defined for the object, the trajectory matrix being a matrix in which two-dimensional coordinates of the keypoint of the chronological keypoint coordinate group are plotted as a trajectory of a curve of the two-dimensional coordinates that is smoothly continuous in chronological order; and
classifying a behavior of the object based on the trajectory matrix group.

4. A non-transitory computer-readable medium having computer-executable instructions that, upon execution of the instructions by a processor of a computer, cause the computer to function as the behavior classifier according to claim 1.
